(19) United States
(12) Patent Application Publication
(10) Pub. No.: US 2015/0322217 A1
(43) Pub. Date: Nov. 12, 2015

(54) POLYESTER RESIN COMPOSITION AND POLYESTER FILM USING SAME

(71) Applicant: KOLON INDUSTRIES, INC., Gwacheon-si, Gyeonggi-do (KR)

(72) Inventor: Yuin JUNG, Busan (KR)

(73) Assignee: KOLON INDUSTRIES, INC., Gwacheon-si, Gyeonggi-do (KR)

(21) Appl. No.: 14/411,325

(22) PCT Filed: Jun. 28, 2013
(86) PCT No.: PCT/KR2013/005745

§ 371 Date: Dec. 24, 2014

(30) Foreign Application Priority Data
Jun. 29, 2012 (KR) 10-2012-0070732
Jun. 27, 2013 (KR) 10-2013-0074137

(51) Int. Cl. C08J 5/18; C08K 9/02; C08J 3/20

(52) U.S. Cl. CPC C08J 5/18; C08J 3/203; C08K 9/02; C08J 2367/02

(57) ABSTRACT

Provided are a polyester resin composition and a polyester film using thereof, and more particularly, a polyester resin composition including a polyester resin and silica particles coated with a metal compound to prevent an inner defect due to particle agglomeration, and have an excellent surface property of the film, low haze, and an improved transparency, thereby being appropriate for a release film and an optical film for an electronic material, and a polyester film using thereof.

### TECHNICAL FIELD

The present invention relates to a polyester resin composition and a polyester film using thereof, and more particularly, to a polyester resin composition including a polyester resin and silica particles coated with a metal compound to prevent an inner defect due to particle agglomeration, and have an excellent surface property of the film, low haze, and an improved transparency, thereby being appropriate for a release film and an optical film for an electronic material, and a polyester film using thereof.

### BACKGROUND ART

In general, polyester, and in particular, polyethyleneterephthalate (hereinafter, referred to as PET) has been used as a film, a fiber, a container or a bottle and a mechanical and electronic component due to excellent heat resistance, mechanical strength, transparency, chemical resistance, and the like. In addition, the polyester is cheaper than other high functional resins, such that the use and used amount thereof have gradually and continuously increased. In particular, a polyester film which is currently technologically produced has been widely used in various fields such as a base film for magnetism recording medium, various packages, product protection, electronic material, lamination, window, and release film, and in recent years, a market centering on a base film for an electronic material and an optical film has been expanded together with development of various electronic products for a display.

The polyester film has excellent stability of physical property over a large temperature range from a low temperature to a high temperature, excellent chemical resistance as compared to other polymer resins, good mechanical strength, good surface property, good uniformity of thickness, and excellent adaptability to various applications or process conditions, such that it is capable of being applied to a condenser, a photographic film, a label, a pressure-sensitive tape, an ornamental laminate, a transfer tape, a polarizer, a ceramic sheet, and the like. Further, the demand of the polyester film has been increased day by day so as to meet the recent high-speed and automated trends.

The polyester film used in a display field has been used for a base film for a touch panel that is subjected to processes, such as a hard coating process through an offline coating so as to be used in a liquid crystal display device, a film used for a plasma display panel (PDP) film, a base film used for a diffusion sheet included in a backlight unit, a prism lens sheet, a prism protective film, or the like, a base film for an anti-reflective coating so as to prevent glaring caused by light from the outside, and the like.

The above-described base film used in the display field is required to have various features such as process drivability, scratch resistance, light transmittance, excellent brightness and sharpness, and the like, such that a technology of minimizing inner defects and surface defects deteriorating excellent transparency and flatness has been demanded. In addition, in the case of the film used as a release film, the film is attached to an electronic material in a post-process and detached therefrom, such that it is required to control low surface roughness and uniform surface roughness as well as the defects of a base film.

Herein, the defect, which is defined in the present invention, wherein the inner defect indicates a factor which is present in the polyester resin and has a different refractive index to cause reflection and scattering of light, thereby deteriorating transparency of the polyester resin, and the defects may be caused by an inorganic metal, foreign materials, particle agglutination, and a carbide. Further, the surface defect indicates a factor which is present on a surface of the polyester film to cause reflection and scattering of light, and problems such as a scratch, a surface roughness, or the like, in the post-processes.

In order to be used as an electronic material release film as well as a base film in a display field, the film should have an optical specificity and various requirements are required. When the film has poor flatness, which is one of the properties required for the film, tension is not uniform in the manufacturing process of the base film to cause a slipping phenomenon, such that a scratch defect, or the like, occurs on the surface of the film and an applied amount is not uniform in a post-processing coating process, such that a partial applying defect occurs, thereby degrading value of products.

In addition, when the scratch occurs on the base film, with respect to the scratched portion, a black spot, which is an electrical defect, may occur due to the non-uniform coating on the transparent conductive layer, or the non-uniform coating in the post-processing process such as the hard coating, or the like, may occur, such that scratch resistant property is needed.

In a process of producing the film using a general polyester resin, an amorphous sheet molded by an extrusion die is passed through a number of rolls, stretched and wound in a roll film, followed by slitting, herein, in order to pass through the number of rolls, or to be wounded, an appropriate roughness should be provided on the film. To this end, a catalyst added at the time of polymerizing polyester is generally combined with a polyester component or a phosphorus component and an inner deposition particle generated by decreased solubility as to polyester is used, such that the roughness may be provided. However, in the case of using the inner deposition particle, the particle is present in the polyester resin to function as an inner defect and it may even function as a fatal disadvantage in a high quality optical film. In addition, in the case of using external inorganic or organic particles, a process passing performance, for example, a surface defect such as a scratch of the surface of the film, anti-wrinkle of the film wounded by the roll, and an excluded end surface of the film are increased. Meanwhile, transparency of the film may be deteriorated and a deviation between high surface roughness and low surface roughness may be increased to deteriorate flatness.

Korean Patent Laid-Open Publication No. 10-2004-0062245 (Patent Document 1) discloses a biaxially oriented polyester film added porous spherical silica having large oil absorption thereto; however, a compatibility between a polyester resin and silica is not desired to cause a void, thereby deteriorating a transparency of the film.

Therefore, research into a polyester resin composition in which the compatibility with the polyester resin is excellent and the particles are not agglomerated in the resin to decrease the inner defects, such that flatness and scratch resistance of the film are excellent, surface roughness is low, and transparency is high has been conducted.

### RELATED ART DOCUMENT

(Patent Document 1) Korean Patent Laid-Open Publication No. 10-2004-0062245 (Jul. 7, 2004)

### DISCLOSURE

### Technical Problem

An object of the present invention is to provide a polyester resin composition in which inner defects of a polyester resin and a polyester film are decreased, flatness is excellent, surface roughness is low, a deviation in roughness is small, surface scratches and abnormal defects do not exist, haze is low, and transparency is excellent.

In addition, another object of the present invention is to provide a polyester film having low roughness and high transparency which is appropriate for a release film or an optical film for an electronic material by using the polyester resin composition.

Further, another object of the present invention is to provide a method of preparing a polyester resin composition and a polyester film having the low roughness and high transparency.

### Technical Solution

In one general aspect, there is provided a polyester resin composition including: a polyester resin and a silica particle coated with a metal compound, wherein the silica particle satisfies the following equation 1 and a circumferential angle of the silica particle from any three points at Pₘₐₓ is 85 to 90 degrees:

0.9≦Pₘᵢₙ/Pₘₐₓ≦1.0 [Equation 1]

(In Equation 1, Pₘᵢₙ is a minimum diameter of the silica particle, and Pₘₐₓ is a maximum diameter of the silica particle.)

The silica particle coated with the metal compound may have an average particle size of 0.1 to 1.0 μm, the metal compound may have a coated thickness of 0.01 to 0.1 μm, and the silica particle coated with the metal compound may be contained in an amount of 0.001 to 0.3 wt % in the polyester resin composition.

The silica particle coated with the metal compound may have a 90% accumulated particle size (d90) of 0.3 to 0.8 μm and a maximum particle size (dₘₐₓ) of 0.4 to 1.0 μm, and the metal compound may be any one or two or more selected from a group consisting of alumina, zirconia, titanium oxide, tin oxide, and zinc oxide.

The polyester resin composition may further include a catalyst, electrostatic pinning agent, and a phosphorus compound, wherein the catalyst, the electrostatic pinning agent, and the phosphorus compound may satisfy the following equations 2 to 5:

50≦Me^{C}≦200 [Equation 2]

30≦Me^{P}≦200 [Equation 3]

100≦Me^{C}+Me^{P}≦300 [Equation 4]

30≦P≦100 [Equation 5]

(In Equation 2, Me^{C} is a content (ppm) of a metal contained in the catalyst with respect to total polyester resin composition, in Equation 3, Me^{P} is a content of a metal contained in the electrostatic pinning agent with respect to the total polyester resin composition, in Equation 4, Me^{C}+Me^{P} are the total content (ppm) of a metal of the catalyst and the electrostatic pinning agent with respect to the total polyester resin composition, and in Equation 5, P is a content (ppm) of phosphorus contained in a phosphorus compound with respect to the total polyester resin composition.)

The number of defects having a size of 1.5 μm or more in an area of 448 μm×336 μm may be 7 or less.

In another general aspect, there is provided a polyester film produced by using the above-described polyester resin composition, followed by melt-extrusion and stretch.

The polyester film may contain 0.001 to 0.3 wt % of silica particles coated with a metal compound and may have a haze less than 5% and a surface roughness (Ra) less than 15 nm.

In another general aspect, there is provided a method of preparing a polyester resin composition including: mixing silica particles coated with a metal compound at the time of synthesizing a polyester resin, wherein the silica particle satisfies the following equation 1 and a circumferential angle of the silica particle from any three points at Pₘₐₓ is 85 to 90 degrees:

0.9≦Pₘᵢₙ/Pₘₐₓ≦1.0 [Equation 1]

(In Equation 1, Pₘᵢₙ is a minimum diameter of the silica particle, and Pₘₐₓ is a maximum diameter of the silica particle.)

In the mixing of the silica particles, the silica particle coated with the metal compound may be dispersed in glycols and mixed in a slurry state.

### Advantageous Effects

According to the present invention, the polyester resin composition may contain the spherical silica coated with the metal compound, such that the dispersibility of the particle in the resin may be increased and the frictional force on the surface of the film may be decreased to decrease the inner defects of the film at the time of producing the film.

In addition, at the time of preparing the polyester resin, the contents of the metal and phosphorus contained in the resin are adjusted in accordance with the contents of the catalyst, the electrostatic pinning agent, and the phosphorus compound, such that the defects present in the resin may be decreased and the surface properties may be improved together with the spherical silica coated with the metal compound.

Further, the compatibility between the polyester resin and the spherical silica coated with the metal compound is excellent, such that the flatness and the process drivability may be excellent, and the film without the surface scratch or abnormal defect may be formed.

Therefore, the film having excellent transparency and surface properties may be produced.

### DESCRIPTION OF DRAWINGS

The above and other objects, features and advantages of the present invention will become apparent from the following description of preferred embodiments given in conjunction with the accompanying drawings, in which:

FIG. 1 is a conceptual diagram showing a maximum diameter and a circumferential angle of a silica particle coated with a metal compound of the present invention.

### BEST MODE

Hereinafter, a preferred exemplary embodiment and evaluation factors with respect to a method of preparing a polyester resin composition and a film will be described in detail. The present invention may be specifically appreciated by the following exemplary embodiments, and the exemplary embodiments are given by way of illustration but are not intended to limit the protective scope defined by the attached claims of the present invention.

The present invention is directed to a polyester resin composition containing a spherical silica coated with a metal compound to increase dispersibility of particles and decrease surface frictional force of a film, thereby decreasing defects in the film at the time of producing the film, and a polyester film having low roughness and high transparency using the same.

The present inventors found that an organic or inorganic particle added as an anti-blocking agent in polymerization of the polyester resin is caused by inner defects and surface defects at the time of producing the polyester film. In addition, the present inventors found that since the anti-blocking agents are agglomerated with each other in the polyester resin, compatibility with the polyester resin is not excellent to cause a void in stretching the film, and the void functions as the inner and surface defects. Further, the present inventors found that a particle size is increased to increase surface roughness of the film, and due to imbalance of the roughness, a deviation in roughness is increased to decrease flatness, such that coating solution and slurry may not be uniformly coated in post-processes.

Therefore, the present inventors found that within a range in which optical property and surface property of the film produced by using the polyester resin composition are not deteriorated, that is, a range in which haze is 5% or less, and an average surface roughness Ra is 15 nm or less, spherical silica is used, the spherical silica being coated with the metal compound and having sphericity close to 1, to thereby provide an optical polyester resin composition having decreased inner defect, low haze, and excellent surface property, thereby completing the present invention.

Hereinafter, the present invention will be described in detail.

The polyester resin composition of the present invention may contain a silica particle coated with a polyester resin and a metal compound.

The metal compound, which is coated on the silica particle to improve compatibility with the polyester resin, may have significantly excellent transparency by being coated with the metal compound having high affinity with the polyester resin even in the silica particle having the same average particle size. The metal compound may be used without limitation, and in particular, any one or two or more selected from a group consisting of zirconia, alumina, titanium oxide, tin oxide, and zinc oxide is effective for improving the affinity with the polyester resin.

The metal compound is preferably coated on the surface of the silica in a thickness of 0.01 to 0.1 μm, and more preferably, 0.05 to 0.1 μm. In the case in which the metal compound is coated in the above-described thickness, the compatibility with the polyester resin may be effectively improved, and in the case of producing a film by using the metal compound, the void may be suppressed to improve the transparency and decrease the haze.

In the case in which a coated thickness of the metal compound is less than 0.01 μm, the coating thickness is extremely thin, such that it is difficult to improve the affinity with the polyester resin, and in the case in which the coated thickness is more than 0.1 μm, the entire size of the particle is increased which increases the surface roughness, such that the flatness may be deteriorated, and dispersion of light may be caused to decrease the transparency.

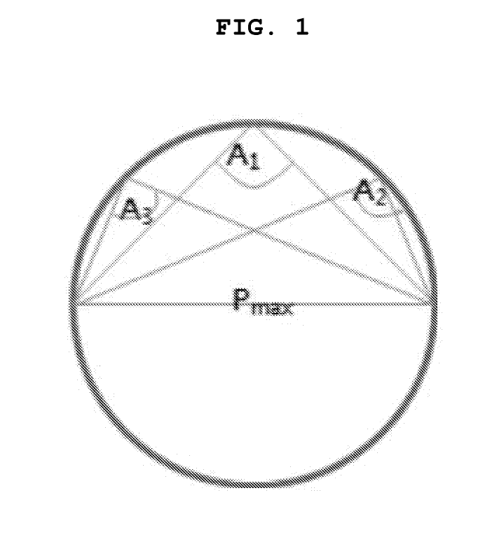

It is preferred that the silica particle coated with the metal compound satisfies the following equation 1, and a circumferential angle (A1-A3) from any three points at the maximum diameter Pₘₐₓ shown in FIG. 1 is 85 to 90 degrees:

0.9≦Pₘᵢₙ/Pₘₐₓ≦1.0 [Equation 1]

(In Equation 1, Pₘᵢₙ is a minimum diameter of the silica particle, and Pₘₐₓ is a maximum diameter of the silica particle.)

The maximum size and a spherical shape of the silica particle coated with the metal compound may be measured by a scanning electron microscope (SEM) photograph, and a ratio between the minimum diameter (Pₘᵢₙ) and the maximum diameter (Pₘₐₓ) defined in the above equation 1 is 0.9 to 1.0, such that the silica particle is substantially spherical, which is effective. In the case in which the silica particle coated with the metal compound is spherical, the smallest amount thereof may be used to significantly and effectively maintain drivability of the film.

In the present invention, “the minimum diameter” means the minimum diameter of each of 20 or more particles based on the SEM photograph, and “the maximum diameter” means the maximum diameter of each of 20 or more particles based on the SEM photograph.

The average particle size of the silica particle coated with the metal compound may be 0.1 to 1.0 μm, and in the case of measuring the particle size by using a size distribution analyzer using a laser diffraction-scattering scheme and when volume from the small particle size is accumulated, it is effective to satisfy that the particle size corresponding to 90%, that is, d90 value is 0.3 to 0.8 μm, and dₘₐₓ value that is the maximum particle size is 0.4 to 1.0 μm.

In the case in which the average particle size of the silica particle coated with the metal compound is less than 0.1 μm, the transparency is excellent, the processability is decreased, and the particles are reagglomerated to be a large particle, such that there may be a defect at the time of producing the film, and in the case in which the average particle size is more than 1.0 μm, the processability is improved, but the surface roughness is increased and the surface is uneven, such that the surface property may be deteriorated, and the scattering of the light may be caused to deteriorate the transparency. In addition, the silica particle coated with the metal compound exists as the defect of the surface, such that transmittance is decreased and the void is formed, whereby the film is broken during a stretching process to deteriorate productivity of the polyester film.

Further, the silica particle coated with the metal compound may be contained in an amount of 0.001 to 0.3 wt % in the polyester film using the polyester resin composition having low roughness and the high transparency. The polyester film having an amount of the above-described range has not only excellent transparency and flatness but also excellent processability, that is, drivability, such that scratches or abnormal defects are not generated on the surface of the film.

In the case in which the silica particle coated with the metal compound is contained in an amount of less than 0.001 wt %, an effect of improving the flatness and the processability is not significant, such that the scratches and the abnormal defects at the time of producing the film may be largely generated, and in the case in which the silica particle is contained in an amount of more than 0.3 wt %, large amounts of particles may be agglomerated with each other to cause a surface defect at the time of producing the film, the surface roughness may be increased, the transparency may be deteriorated, and the haze may be high.

In the present invention, the polyester resin may be a general polyester homopolymer or a general polyester copolymer which may be prepared by an esterification reaction or an esterification exchange reaction, for example, a melting polycondensation of dicarboxylic acid or an ester derivative thereof and glycol or an ester derivative thereof, and more preferably, the polyester resin may be a polyester resin obtained by polymerization of a metal catalyst and an electrostatic pinning agent.

As the dicarboxylic acid or the ester derivative thereof, terephthalic acid or alkylester or phenylester thereof, or the like may be mainly used, but a portion thereof may be used by being substituted with, for example, bifunctional carboxylic acid, such as isophthalic acid, oxyethoxy benzoic acid, adipic acid, sebacic acid, 5-sodiumsulfoisophthalic acid, or ester forming derivatives thereof. In addition, the glycol or the ester derivative thereof may be generally ethyleneglycol but a portion thereof may be used by being substituted with, for example, 1,3-propanediol, trimethyleneglycol, 1,4-butanediol, 1,4-cyclohexanediol, 1,4-cyclohexanedimethanol, neopentylglycol, 1,4-bisoxyethoxybenzene, bisphenol, polyoxyethyleneglycol, and a small amount of monofunctional compound or the trifunctional compound may be used.

In the present invention, the catalyst is not limited as far as the catalyst is used during the polycondensation of the polyester. More preferably, a metal catalyst such as tin, antimony, or the like, may be used, and more specifically, an antimony compound, a germanium compound, a titanium compound, or the like, may be used.

The content of the metal in the catalyst may satisfy the following equation 2, and more preferably, the content of the metal present in the metal catalyst may be 50 to 150 ppm in total polyester resin composition.

50≦Me^{C}≦200 [Equation 2]

(In Equation 2, Me^{C} is a content (ppm) of the metal contained in the catalyst with respect to total polyester resin composition.)

In the case in which the content of the metal present in the catalyst is less than 50 ppm, the effect obtained by using the catalyst is not significant, and in the case in which the content of the metal is more than 200 ppm, the metal may be deposited from the resin due to excessive metals, or a complex may be formed to cause the inner defect.

The electrostatic pinning agent in the present invention is not limited as far as it is generally used, and more preferably, a bivalent metal compound may be used, and more specifically, an alkali metal compound, an alkali earth metal compound, a manganese compound, a cobalt compound, and a zinc compound may be used due to large electrostatic activity, and as a specific example thereof, magnesium acetate, sodium acetate, calcium acetate, lithium acetate, calcium phosphate, magnesium oxide, magnesium hydroxide, magnesium alkoxide, manganese acetate, and zinc acetate may be used, and one or two or more thereof may be mixed to be used.

The content of the metal present in the electrostatic pinning agent may satisfy the following equation 3, and more preferably, may be contained in an amount of 50 to 150 ppm in total polyester resin composition.

30≦Me^{P}≦200 [Equation 3]

(In Equation 3, Me^{P} is a content (ppm) of the metal contained in the electrostatic pinning agent with respect to total polyester resin composition.)

In the case in which the total content of the metal in the electrostatic pinning agent is within the above-described range, the film in which the drivability is increased, the inner defects are decreased, and the haze is low may be produced. Meanwhile, in the case in which the electrostatic pinning agent is used in an amount of less than 30 ppm, an effect in which the drivability is improved due to the use of the electrostatic pinning agent may not be obtained, such that at the time of producing the film, the drivability may be deteriorated to cause the defects, and in the case in which the electrostatic pinning agent is used in an amount of more than 200 ppm, agglomeration or the complex may be formed due to excessive metals to cause the inner defects.

In addition, the total content of the metal contained in the catalyst and the electrostatic pinning agent may satisfy the following equation 4.

100≦Me^{C}+Me^{P}≦300 [Equation 4]

(In Equation 4, Me^{C}+Me^{P} are the total content (ppm) of the metal of the catalyst and the electrostatic pinning agent with respect to the total polyester resin composition.)

In the case in which the total content of the metal is less than 100 ppm, the effect of using the catalyst and the effect of improving the drivability may not be significant, and in the case in which the total content of the metal is more than 300 ppm, due to the excessive metal, the metal may be deposited from the resin or the complex may be formed to cause the inner defects, such that it is preferred that the total content of the metal may be contained in an amount of the above-described range.

The present invention may further include a phosphorus compound in order to provide a thermal stability, wherein the phosphorus compound may be trimethylphosphate, triethylphosphate, and a phosphoric acid as needed. The phosphorus compound may further provide an effect in which a pinning property is improved together with thermal stability.

The content of the phosphorus present in the phosphorus compound may satisfy the following equation 5, and more preferably, may be contained in an amount of 30 to 60 ppm in a total polyester resin composition.

30≦P≦100 [Equation 5]

(In Equation 5, P is a content (ppm) of the phosphorus contained in the phosphorus compound with respect to a total polyester resin composition.)

More preferably, in the case in which Equation 6 is satisfied and a melt resistance of the prepared resin satisfies 2 to 8MΩ, the inner defect may be minimally deposited by the metal catalyst and the film having low haze may be produced.

0.5≦[P]/[Me^{P}]≦1.5 [Equation 6]

(In Equation 6, [P] is an equivalence of phosphorus in the phosphorus compound, and [Me^{P}] is a sum of total equivalence of the metal in the metal compound used as the pinning agent.)

Equation 6 is directed to an equivalent ratio between a negative ion resulted from phosphorus and a positive ion resulted from the metal, wherein a current applied to a casting drum is generally negative (−), such that the polyester resin composition may be positive (+) in order to provide the pinning property, and to this end, when the phosphorus compound is added as described above, the equivalent ratio may be controlled so that the composition is positive (+). In the case in which the equivalent ratio is less than 0.5 or the melting resistance is less than 2, the drivability and the processability may be increased, but the inner defects may be caused by excessive metal of the electrostatic pinning agent and a color of a polymer resin may be yellowed, and in the case in which the equivalent ratio is more than 1.5 or the melting resistance is more than 8, an electrostatic spinning property is not sufficient, such that it is difficult to normalize a driving rate of the film, productivity may be deteriorated, the processability may be degraded, surface scratches such as a pinning scratch, or the like, may be generated, and an appearance defect may be caused.

In addition, the composition of the present invention may further include general additives such as any one or two or more color improving agents selected from a group consisting of a secondary flame retardant, a pigment or a dye, a reinforcing agent such as a glass fiber, or the like, a filler, a heat resistant, a shock absorber, a fluorescence whitening agent for improving color, and a germanium compound containing germanium oxide.

In the present invention, the silica particle coated with the metal compound may be combined at the time of synthesizing the polyester resin, and more specifically, the dicarboxylic acid or the ester derivative thereof and the glycol or the ester derivative thereof are combined to each other to prepare a slurry, followed by a direct esterification reaction, to prepare a low molecular material (oligomer having low molecular weight); and the electrostatic agent and the phosphorus compound are added to the low molecular material, additional additive is added thereto, and combined with the silica particle coated with the metal compound dispersed in glycols, followed by a polycondensation reaction, to prepare the polyester resin composition may be included in preparing the silica particles.

More specifically, in order to produce the polyester film having excellent surface property and transparency in the present invention, the spherical silica particles are primarily combined with glycol to prepare a slurry by using a high speed agitator, followed by filtering, classification or grinding, to be used for producing the polyester film. The glycols within (C2˜C10) glycol may be used without limitation, and in particular, ethyleneglycol may be used to improve dispersion stability. In addition, in order to increase dispersion stability in the slurry, dispersants such as a phosphate salt, a surface treating agent, and the like, may be added.

The polyester resin composition according to the present invention may satisfy physical properties in which the number of defects having a size of 1.5 μm or more in an area of 448 μm×336 μm is 7 or less. The composition satisfying the physical property of above-described range may be appropriate for a release film and an optical film for an electronic material.

Next, a method of producing the polyester film of the present invention will be described.

In the present invention, the polyester composition is used to produce the polyester film by a general production, for example, an unstretched sheet is obtained by melting extrusion with a known T-die of the related art, the obtained unstretched sheet is stretched by 2 to 7 times, preferably, 3 to 5 times, in a machine direction, and the stretched sheet is stretched again by 2 to 7 times, preferably, 3 to 5 times, in a transverse direction with respect to the machine direction, to thereby produce the polyester film.

Further, the thickness of the produced film is 1 to 500 μm, and in the case of the polyester film having a single layer or a number of stacked layers, at least one layer may be configured of a polyester film according to the present invention. For example, at the time of producing the polyester resin, the spherical silica particles are added, or the previously prepared polyester resin and the spherical silica particles are compounded with each other, and the resin containing the particles added thereto and the polyester resin not containing particles are appropriately combined to each other to mold the film, thereby obtaining the polyester film having low roughness and high transparency.

In addition, in the film having a single layer or a number of stacked layers, the spherical silica particles included in at least one surface layer (the outermost layer) may be contained in an amount of 0.001 to 0.3 wt % with respect to the polyester resin.

Hereinafter, Examples will be provided in order to describe the present invention in more detail. However, the present invention is not limited to the Examples below.

Physical properties were measured by the following measuring methods.

1) Sphericity and Maximum Size of Particle

The minimum diameter (Pₘᵢₙ) and the maximum diameter (Pₘₐₓ) of the particle could be measured by using a scanning electron microscope (SEM) photograph of the particle, and thus, the minimum diameters and the maximum diameters for particles were measured, respectively, and sphericity was determined by an average calculated as the maximum diameter (Pₘₐₓ) divided by the minimum diameter (Pₘᵢₙ). In addition, an average of the circumferential angle with respect to any three points from the maximum diameter was calculated.

2) Particle Size in Slurry

Particle sizes in slurry, d90 and dmax were measured by using a laser light scattering diffraction type size distribution analyzer (model no. LS1300) manufactured by Beckman-Coulter Inc.

3) Number of Inner Defects

A polyester resin composition chip prepared as a pellet was melted on a slide glass to prepare a sample having a thickness of 500 μm, a depth-180 μm layer defect was observed by an optical microscope of 200^{th} magnifications in a transmitted light, and the number of defects having a size of 1.5 μm or more in an area of 448 μm×336 μm was calculated by an average number of a total of five microscope photographs. In addition, a size of the defect was measured by the scale bar of microscope based on a long axis of the defect.

4) Melt Resistance

Melt Resistance was measured for a pinning property.

To this end, 0.5 g of polyester resin composition chip was positioned in a frame made of teflon, and an aluminum electrode is connected to upper and lower portions of the chip to prepare a sample. After the sample was melted for 5 mins at 285° C., 0.7 to 1.0 mPa of pressure is applied thereto, and an electrical resistance value after 13 mins was measured. When the resistance value is 2 to 8(×MΩ), the polyester resin composition chip may be applied to a process of producing a film.

5) Haze

A polyester resin prepared by using a pilot film forming machine was melted by an extrusion T die and cooled by a casting drum to prepare a sheet having a thickness of 1690 μm, and the prepared sheet was stretched by three times in horizontal and vertical directions to prepare a sheet having a thickness of 188 μm. Then, haze of the prepared film was measured.

The haze was measured based on an ASTM D-1003 standard, and 7 portions of the film which were randomly extracted from 2 side portions thereof, one central portion thereof are cut to have each size of 5 cm×5 cm, and put into a haze meter (Nippon Denshoku NDH 300A). Then, a light having a wavelength of 555 nm was passed through the film, the haze was calculated by using the following equation, and an average value thereof except for the maximum value/the minimum value was calculated.

Haze=(total scattering light/total transmitting light)×100

6) Film Surface Roughness

After a polyester film was cut into 3 portions of left/middle/right side based on JIS B0601, and cut again to have each size of 3 cm×3 cm. Then, a surface roughness measuring instrument of Kosaka Laboratory, Japan, was used to measure two dimensional surface roughness from at least five film surfaces under the following measurement conditions and evaluate the average surface roughness Ra (nm).

$${R}_{a} = \frac{1}{L} {\int }_{0}^{L} \vert f ( x ) \vert d x$$

(L: Measurement Length)

Speed: 0.05 mm/s

Cut off: 0.08 mm

Measurement Length (L): 1.50 mm

7) Film Drivability (Coefficient of Friction) Measurement

Film drivability was shown as the coefficient of friction and the coefficient of friction was measured by ASTM D-1894. The measurement was performed under a temperature of 23±1° C., and humidity of 50±5% RH, wherein the used sample had a size in a width of 100 mm and a length of 200 mm, and a tension speed of 200 mm/min.

8) Optical Surface Defect (Glittered Foreign Material and Floated Cloud and Mist)

After the produced film was prepared as a sample having a predetermined size in a width of 20 cm and a length of 20 cm, a three wavelength lamp was flashed on the sample and reflected on a film surface, and every material that glitters with the naked eye was defined as a glittered foreign material. In addition, a three wavelength lamp was flashed on the sample and transmitted on a film and every material that was hazy and buried on the whole surface on the film with the naked eye was defined as a cloud and mist, extents thereof were measured.

\textcircled{1}⊚ (Very Excellent): No Glitters and Cloud and Mist.

\textcircled{2}∘ (Excellent): Small Amounts of Glitters and Cloud and Mist.

\textcircled{3}Δ (Normal): Large Amounts of Glitters and Cloud and Mist.

\textcircled{4}x (Poor): Full Glitters and Cloud and Mist on Whole Surface.

### Example 1

50 parts by weight of ethylene glycol, 400 ppm of magnesium acetate as an electrostatic pinning agent, and 130 ppm of antimony trioxide as a catalyst with respect to 100 parts by weight of dimethylterephthalate were put into an esterification reactor, and were heated under a pressure of 1.5 kg/cm² and a temperature of 255° C., to discharge methanol, followed by a transesterification method for 4 hours, thereby preparing bis-β-hydroxyethyl terephthalate (BHET) as a prepolymer. Methanol generated by the reaction was separated by a distillation column, and after the esterification reaction was completed, added generated ethylene glycol was also separated by the distillation column.

Here, as shown in the following Table 1, based on the prepared BHET, 0.06 wt % of spherical silica particles (solid content 20 wt %) having d90 of dispersed particles of 0.70 μm and coated with a metal compound (alumina) in a thickness of 0.1 μm was put into ethylene glycol, 200 ppm of trimethylphosphate as a heat stabilizer is added thereto, and a temperature is slowly increased from 240° C. up to 285° C., followed by a copolymerization for 4 hours under 0.3 torr of high vacuum, thereby preparing a polyethyleneterephthalate (PET) resin having an intrinsic viscosity (IV) of 0.650.

5% of the prepared PET containing the particles and 95% of PET not containing the particles were blended and melt extruded by an extruder, followed by rapid cool with a casting drum having a surface temperature of 20° C. and solidification, thereby preparing a sheet having a thickness of 2000 μm. 110 μm of the prepared PET sheet was stretched in a machine direction (MD) by 3.5 times and cooled at room temperature. Then, the sheet was preheated at 140° C., followed by drying, and stretched in a transverse direction (TD) by 3.5 times. Next, the sheet was heat-treated at 235° C. and was heat-fixed by stretching the heat-treated sheet by 10% in a machine direction and a transverse direction at 200° C., thereby producing a biaxially oriented film having a thickness of 188 μm and 30 ppm of a particle content in the final film. Physical properties thereof were measured and shown in the following Table 2.

### Example 2

As shown in the following Table 1, a polyester film of Example 2 was produced as the same as Example 1 except that the silica particle having a particle size and a coating thickness of the metal compound different from those of Example 1, was used and the particle content in the produced film was changed. Physical properties of the film of Example 2 were measured and shown in the following Table 2.

### Example 3

As shown in the following Table 1, a polyester film of Example 3 was produced as the same as Example 2 except that the particle content in the film was changed. Physical properties of the film of Example 3 were measured and shown in the following Table 2.

### Example 4

As shown in the following Table 1, a polyester film of Example 4 was produced as the same as Example 1 except that the silica particle having a particle size and a coating thickness of the metal compound different from those of Example 1, was used and the particle content in the film was changed. Physical properties of the film of Example 4 were measured and shown in the following Table 2.

### Comparative Example 1

As shown in the following Table 1, a polyester film of Comparative Example 1 was produced as the same as Example 1 except for using the silica particle which was not spherical but fumed type silica (SY310, Fuji Silysia). Physical properties of the film of Comparative Example 1 were measured and shown in the following Table 2.

### Comparative Example 2

As shown in the following Table 1, a polyester film of Comparative Example 1 was produced as the same as Example 1 except for using the silica particle in which an average particle size thereof was adjusted by performing post-processes including grinding the fumed type silica (SY310, Fuji Silysia) used in Comparative Example 1, followed by classification and filtering of 5 μm. Physical properties of the film of Comparative Example 2 were measured and shown in the following Table 2.

### Comparative Example 3

As shown in the following Table 1, a polyester film of Comparative Example 2 was produced as the same as Example 1 except that the content of the particle used in Comparative Example 2 included in the polyester film was changed. Physical properties of the film of Comparative Example 3 were measured and shown in the following Table 2.

### Comparative Example 4

As shown in the following Table 1, a polyester film of Comparative Example 4 was produced as the same as Example 1 except that the used particle was not a spherical silica but calcium carbonate (Maruo, KM-30), and the particle content in the film was changed. Physical properties of the film of Comparative Example 4 were measured and shown in the following Table 2.

### Comparative Example 5

As shown in the following Table 1, a polyester film of Comparative Example 5 was produced as the same as Example 1 except that the content of the particle used in Comparative Example 4 included in the polyester film was changed. Physical properties of the film of Comparative Example 5 were measured and shown in the following Table 2.

### Comparative Example 6

As shown in the following Table 1, a polyester film of Comparative Example 6 was produced as the same as Example 1 except that the spherical silica particle had an uncoated surface. Physical properties of the film of Comparative Example 6 were measured and shown in the following Table 2.

### Comparative Example 7

As shown in the following Table 1, a polyester film of Comparative Example 7 was produced as the same as Example 1 except that the content of the spherical silica particle included in the film was changed. Physical properties of the film of Comparative Example 7 were measured and shown in the following Table 2.

### Comparative Example 8

As shown in the following Table 1, a polyester film of Comparative Example 8 was produced as the same as Example 1 except that the content of the catalyst, the electrostatic pinning agent, and the phosphorus compound used in preparing a polyester resin were changed, respectively. Physical properties of the film of Comparative Example 8 were measured and shown in the following Table 2.

Physical properties on polyester resin compositions and polyester films prepared in the above-described Examples and Comparative Examples were measured by the above-described physical property measuring method and the results thereof were shown in the following Table 1.

TABLE 1

| | | | | | | Metal Content in Polymer | | |
|---|---|---|---|---|---|---|---|---|
| | | | | | | (ppm) | | |
| | Particle Feature | | | | | Electrostatic | | |
| | | | | Average | Coating | Pinning | | Phosphorus |
| | d90 | dmax | Sphericity | circumferential | Thickness | Agent | Catalyst | Compound |
| Classification | (μm) | (μm) | (Pmin/Pmax) | angle (°) | (μm) | (Mg) | (Sb) | (P) |
| Example 1 | 0.70 | 1.00 | 0.98 | 90 | 0.10 | 50 | 130 | 40 |
| Example 2 | 0.60 | 0.80 | 0.97 | 90 | 0.05 | 50 | 130 | 40 |
| Example 3 | 0.60 | 0.80 | 0.97 | 90 | 0.05 | 50 | 130 | 40 |
| Example 4 | 0.30 | 0.50 | 0.98 | 89 | 0.05 | 50 | 130 | 40 |
| Comparative | 3.40 | 6.80 | Unmeasurable | Unmeasurable | — | 50 | 130 | 40 |
| Example 1 | | | | | | | | |
| Comparative | 0.50 | 3.20 | Unmeasurable | Unmeasurable | — | 50 | 130 | 40 |
| Example 2 | | | | | | | | |
| Comparative | 0.50 | 3.20 | Unmeasurable | Unmeasurable | — | 50 | 130 | 40 |
| Example 3 | | | | | | | | |
| Comparative | 1.00 | 1.70 | Unmeasurable | Unmeasurable | — | 50 | 130 | 40 |
| Example 4 | | | | | | | | |
| Comparative | 1.00 | 1.70 | Unmeasurable | Unmeasurable | — | 50 | 130 | 40 |
| Example 5 | | | | | | | | |
| Comparative | 0.60 | 0.80 | 0.98 | 90 | — | 50 | 130 | 40 |
| Example 6 | | | | | | | | |
| Comparative | 0.60 | 0.80 | 0.97 | 90 | 0.05 | 50 | 130 | 40 |
| Example 7 | | | | | | | | |
| Comparative | 0.70 | 1.00 | 0.98 | 90 | 0.10 | 110 | 250 | 110 |
| Example 8 | | | | | | | | |

TABLE 2

| | | | Film Features | | | | |
|---|---|---|---|---|---|---|---|
| | Defects | | Particle | | Coefficient | | |
| | in | Melt- | Content | | of | Surface | |
| | Resin | Resistance | in Film | Haze | Friction | Roughness | Surface |
| Classification | (ea) | (MΩ) | (ppm) | (%) | (μs) | (Ra, nm) | Defect |
| Example 1 | 4.5 | 4.0 | 30 | 0.8 | 0.35 | 7 | ⊚ |
| Example 2 | 3.5 | 4.0 | 1500 | 3.0 | 0.35 | 12 | ◯ |
| Example 3 | 3.5 | 4.0 | 2500 | 3.5 | 0.36 | 13 | ◯ |
| Example 4 | 3.0 | 4.0 | 3000 | 2.5 | 0.23 | 6 | ⊚ |
| Comparative | 30.0 | 4.0 | 30 | 1.5 | 0.32 | 11 | X |
| Example 1 | | | | | | | |
| Comparative | 17.0 | 4.0 | 500 | 3.3 | 0.29 | 21 | Δ |
| Example 2 | | | | | | | |
| Comparative | 17.0 | 4.0 | 1000 | 3.4 | 0.31 | 20 | Δ |
| Example 3 | | | | | | | |
| Comparative | 5.5 | 4.0 | 2000 | 6.1 | 0.23 | 13 | ◯ |
| Example 4 | | | | | | | |
| Comparative | 5.5 | 4.0 | 2500 | 7.7 | 0.32 | 16 | ◯ |
| Example 5 | | | | | | | |
| Comparative | 7.5 | 4.0 | 30 | 5.3 | 0.36 | 7 | ◯ |
| Example 6 | | | | | | | |
| Comparative | 3.5 | 4.0 | 3500 | 5.5 | 0.39 | 17 | Δ |
| Example 7 | | | | | | | |
| Comparative | 8.0 | 8.5 | 30 | 1.3 | 0.34 | 10 | X |
| Example 8 | | | | | | | |

It may be appreciated from Table 2 above that in Examples 1 to 4 as compared to Comparative Examples 1 to 7, total contents (Me^{C}+Me^{P}) of the catalyst and the metal of the electrostatic pinning agent were less than 300 ppm, the phosphorus content of the phosphorus compound was less than 60 pm, and 0.001 to 0.3 wt % of spherical silica particles coated with the metal compound were contained in the film, such that the inner defect and the surface defects were remarkably decreased.

In addition, since the spherical silica particles coated with the metal compound was used, the haze was also decreased to maintain high transparency, and surface roughness was low and the coefficient of friction was appropriate to have excellent processability and flatness.

Further, in Comparatives Examples 1 to 5, the added particles did not have a spherical shape and did not have a structure which can be defined as a specific shape, such that the measurement of sphericity was impossible, and thus the measurement of the circumferential angle to the maximum diameter was also impossible. Therefore, it may be appreciated that in Comparative Examples 1 to 5, the particles that are not spherical were added thereto, the inner defects and the surface defects were significantly increased, and the haze and the surface roughness were also increased, which is not appropriate for the polyester resin composition for the release film and optical film for the electronic material requiring the low roughness and the high transparency.

In addition, it may be appreciated that in Comparative Example 6, since the particle that are not coated with the metal compound was used, compatibility with the resin was decreased, such that the transparency was remarkably decreased even though particles were contained in small amounts, and in Comparative Example 7, since excessive amounts of the spherical silica particles coated with the metal compound were used, the transparency was decreased, the surface roughness was increased, and the surface defects were increased.

Further, it may be appreciated that in Comparative Example 8, since the catalyst, the electrostatic pinning agent, and the phosphorus compound were used in excessive amounts, respectively, such that the number of defects in the polyester resin was increased by the metal deposition, and due to the increased defects, the defects on the film surface were remarkably increased, and the haze and the surface roughness were also increased.

Therefore, the present invention may provide the film in which the catalyst, the electrostatic pinning agent, and the phosphorus compound are contained in an optimum content, the silica particles coated with the metal compound have appropriate particle size, appropriate content, and appropriate coating thickness of the metal compound, such that the inner or the surface defects are remarkably decreased, the flatness and the process drivability are excellent, the haze of the film is low, and the transparency is excellent, the polyester resin composition preparing the same, and the method for preparing the same.

1. A polyester resin composition comprising:
a polyester resin and a silica particle coated with a metal compound,
wherein the silica particle satisfies the following equation 1 and a circumferential angle of the silica particle from any three points at Pₘₐₓ is 85 to 90 degrees:
0.9≦Pₘᵢₙ/Pₘₐₓ≦1.0 [Equation 1]
(In Equation 1, Pₘᵢₙ is a minimum diameter of the silica particle, and Pₘₐₓ is a maximum diameter of the silica particle.)

2. The polyester resin composition of claim 1, wherein the silica particle coated with the metal compound has an average particle size of 0.1 to 1.0 μm, and the metal compound has a coated thickness of 0.01 to 0.1 μm.

3. The polyester resin composition of claim 1, wherein the silica particle coated with the metal compound is contained in an amount of 0.001 to 0.3 wt % in the polyester resin composition.

4. The polyester resin composition of claim 1, wherein the silica particle coated with the metal compound has a 90% accumulated particle size (d90) of 0.3 to 0.8 μm and a maximum particle size (dₘₐₓ) of 0.4 to 1.0 μm.

5. The polyester resin composition of claim 1, wherein the metal compound is any one or two or more selected from a group consisting of alumina, zirconia, titanium oxide, tin oxide, and zinc oxide.

6. The polyester resin composition of claim 1, further comprising a catalyst, electrostatic pinning agent, and a phosphorus compound,
wherein the catalyst, the electrostatic pinning agent, and the phosphorus compound satisfy the following equations 2 to 5:
50≦Me^{C}≦200 [Equation 2]
30≦Me^{P}≦200 [Equation 3]
100≦Me^{C}+Me^{P}≦300 [Equation 4]
30≦P≦100 [Equation 5]
(In Equation 2, Me^{C} is a content (ppm) of a metal contained in the catalyst with respect to total polyester resin composition, in Equation 3, Me^{P} is a content of a metal contained in the electrostatic pinning agent with respect to the total polyester resin composition, in Equation 4, Me^{C}+Me^{P} are the total content (ppm) of a metal of the catalyst and the electrostatic pinning agent with respect to the total polyester resin composition, and in Equation 5, P is a content (ppm) of phosphorus contained in a phosphorus compound with respect to the total polyester resin composition.)

7. The polyester resin composition of claim 1, wherein the number of defects having a size of 1.5 μm or more in an area of 448 μm×336 μm is 7 or less.

8. A polyester film produced by using the polyester resin composition of claim 7, followed by melt-extrusion and stretch.

9. The polyester film of claim 8, wherein it contains 0.001 to 0.3 wt % of silica particles coated with a metal compound.

10. The polyester film of claim 8, wherein it has a haze less than 5% and has a surface roughness (Ra) less than 15 nm.

11. A method of preparing a polyester resin composition, comprising:
mixing silica particles coated with a metal compound at the time of synthesizing a polyester resin,
wherein the silica particle satisfies the following Equation 1 and a circumferential angle of the silica particle from any three points at Pₘₐₓ is 85 to 90 degrees:
0.9≦Pₘᵢₙ/Pₘₐₓ≦1.0 [Equation 1]
(In Equation 1, Pₘᵢₙ is a minimum diameter of the silica particle, and Pₘₐₓ is a maximum diameter of the silica particle.)

12. The method of claim 11, wherein in the mixing of the silica particles, the silica particle coated with the metal compound is dispersed in glycols and mixed in a slurry state.
